(19) United States
(12) Patent Application Publication
(10) Pub. No.: US 2005/0066507 A1
(43) Pub. Date: Mar. 31, 2005

(54) Assembly process for scrapless clutch plate assembly

(75) Inventor: Paul D. Terpstra, Janesville, WI (US)

Correspondence Address: FOLEY & LARDNER, 321 NORTH CLARK STREET, SUITE 2800, CHICAGO, IL, 60610-4764, US

(73) Assignee: Gilman Engineering & Manufacturing Co., LLC

(21) Appl. No.: 10/672,196

(22) Filed: Sep. 26, 2003

Related U.S. Application Data
(63) Continuation-in-part of application No. 10/668,821, filed on Sep. 23, 2003.

(51) Int. Cl. B23P 11/00

(52) U.S. Cl. 29/429

(57) ABSTRACT

The present invention relates to the assembly of the type of clutch plate referred to as “scrapless”. A method and system in accordance with the principals of the present invention assembles clutch plate assemblies in a more efficient and robust manner. A method and system in accordance with the principals of the present invention provides for a segmented tooling assembly that can be both linear and circular.

### FIELD OF THE INVENTION

The present invention relates to the assembly of the type of clutch plate referred to as “scrapless”.

### BACKGROUND OF THE INVENTION

Prior art clutch plates use a flat ring of a fabric-like clutch material bonded to one or both sides of a metal ring. This metal ring has a spline on its inside diameter to transfer the torque placed on the clutch. The ring of clutch material is cut from a strip of the material, leaving a certain amount of scrap to be disposed of. In contrast, the “scrapless” type of clutch uses trapezoidal shaped segments placed side-by-side to form a circular interrupted ring of the material.

In the prior art, the trapezoidal segments are placed in a nest and then the steel ring is placed on top of the segments. The segments are then bonded to one side of the steel ring by means of pressure and heat. The ring and segments are then removed from the assembly nest, a second set of segments are placed in the nest. The ring must then be inverted and placed again on top of the segments and the bonding process repeated.

In common practice the segments are placed in a rotatable circular fixture to form the required circular shape. The complete set of segments is then transferred to a rotary dial which transfers the segments to a second station where the steel ring is placed on top of the segments. The segments and steel ring are then transferred by the indexing dial to the bonding station where heat and pressure are applied to the assembly. The one-sided assemblies are then removed from the machine and reloaded in to the machine in an inverted orientation at the steel ring load station. At this station the one-sided assembly is placed over a second set of segments and returned again to the bonding station.

As an alternative, the first set of segments and steel ring can be placed into the assembly fixture as described above and a small amount of adhesive placed on the topside of the steel ring. It may be necessary to heat this assembly to a temperature where the adhesive becomes “tacky” at this point. The second set of segments in then placed on top of the steel ring and the assembly is transferred into the bonding station.

A disadvantage of the prior art process is that many segments are required to assemble each clutch plate. In the prior art process, very low cycle times are required for each segment placement in order to achieve a reasonable assembly rate for the complete assembly. For example, if 32 segments are required on each side of each clutch plate, a total of 64 segment placements are required for each clutch plate. In order to process a very modest 200 clutch plates per hour, 12,800 segments must be placed into nests every hour giving a very short 0.28 seconds for each placement operation. This speed is attainable, but creates many challenges in the areas of machine troubleshooting, machine maintenance, and robustness of machine longevity, for example. Another disadvantage of the prior art is the removal and reinsertion of the one-sided assembly in order to produce a final two-sided assembly.

What would therefore be desirable would be a method and system to assemble clutch plate assemblies in a more efficient and robust manner.

### SUMMARY OF THE INVENTION

A method and system in accordance with the principals of the present invention assembles clutch plate assemblies in a more efficient and robust manner. A method and system in accordance with the principals of the present invention provides for a segmented tooling assembly that can be both linear and circular.

### BRIEF DESCRIPTION OF THE DRAWINGS

FIG. 1 depicts a segmented clutch material.

FIG. 2 depicts a segmented tooling assembly.

FIG. 3 depicts a clutch plate assembly system.

### DETAILED DESCRIPTION OF THE INVENTION

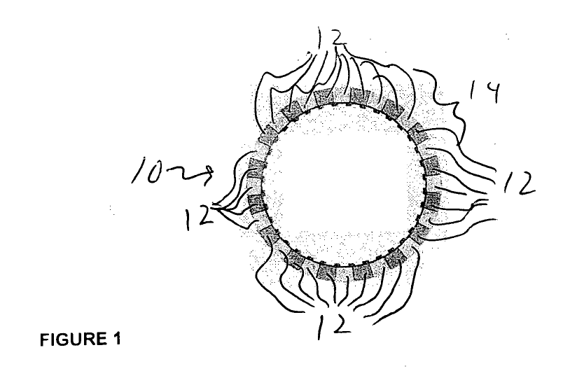

Referring to FIG. 1, segmented clutch material 10 is seen. The segmented clutch material 10 includes a plurality of segments 12 placed side-by-side to form a circular ring of material 14. The segments 12 are preferably trapezoidal shaped. The assembly process of the prior art calls for placing a single segment into one of a series of nest machined into a rotating ring. After each segment is placed (or pushed) into its nest the ring of nests is rotated so that the next segment may be placed into a nest. This is the process that results in many segments being required to assemble each clutch plate thus requiring very low cycle times for each segment placement in order to achieve a reasonable assembly rate for the complete assembly.

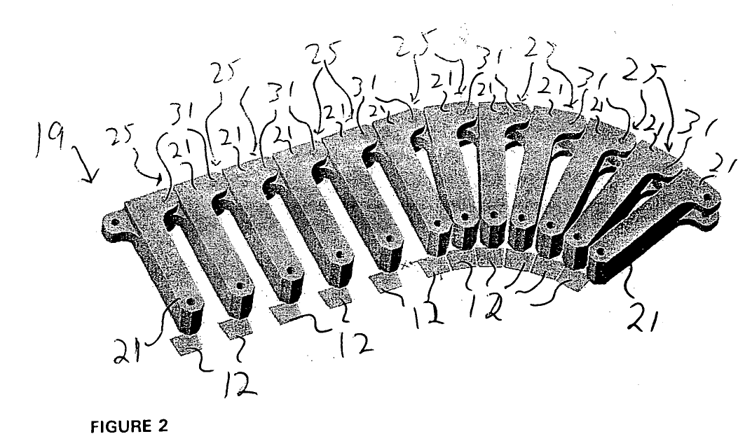

Referring to FIG. 2, a segmented tooling assembly 19 is seen. The segmented tooling assembly 19 includes a plurality segments tools 21. Each of the segment tools 21 is joined at a pivot point 25 that comprises a pin assembly 31. Numerous methods of changing the configuration of the tooling from a straight line into a circular configuration are within the scope of the present invention. In one embodiment, the clutch assembly includes a track that has both a straight portion and a circular portion for the segment to travel. By driving the segments from the straight section to the circular section the configuration is changed.

In another embodiment, the clutch assembly includes a barrel to which one end of the segmented tooling assembly is attached, the barrel rotates to wrap the segmented tooling assembly around the barrel in a circular fashion. In another embodiment, the clutch assembly includes a barrel to which the center of the segmented tooling assembly is attached, and two arms or links to which the two ends of the segmented tooling assembly are attached to wrap and unwrap the segmented tooling assembly around the barrel.

In accordance with the principles of the present invention, a pick-up head assembly is provided. The pick-up head assembly includes a pick-up device on each segment. In an embodiment, the pick-up device comprises a vacuum cup. In accordance with the principles of the present invention, the pick-up head assembly is segmented in such a way that it can be configured in a straight line to pick up the required number of segments and then configured in a circle to place the segments in a circular configuration.

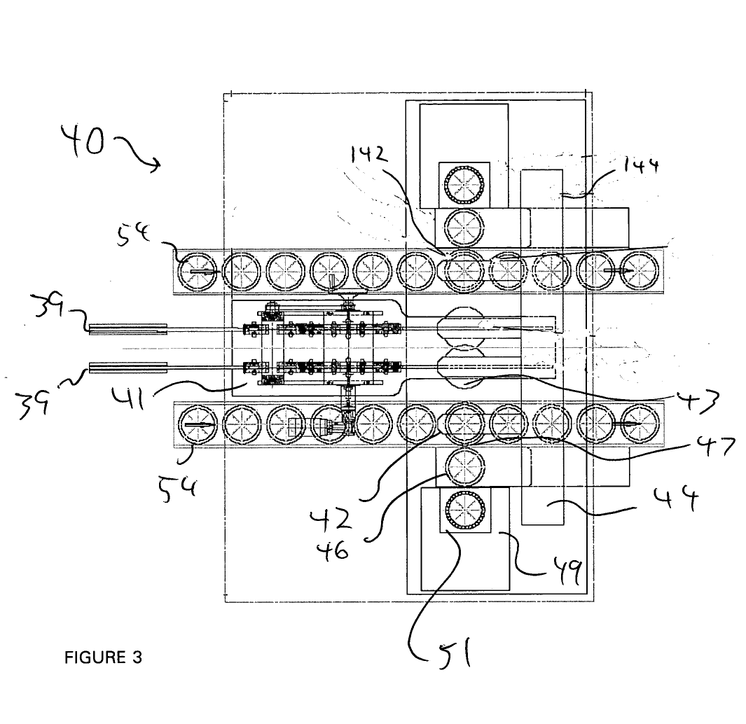

The complete assembly process is described in FIG. 3. Two parallel strips of friction material 39 are fed into an assembly device 40 and cut into alternating left-hand, right-hand trapezoids in a cut and feed area 41, using known practices. The segments are fed in straight lines after being cut to a pick-up position 43. The segments are picked up using the pick-up head assembly described above.

A tooling head 42 is mounted to a linear actuator, preferably a linear servomotor 44, which then transfers the tooling head 42 to a bonding press 49. If the segments are rejected, the tooling head 42 deposits the rejected segments into a reject chute 42. At the bonding press 49, the segments are placed into an assembly nest 51. The tooling head 42 changes from the linear configuration to the circular configuration during this transfer.

While the tooling head 42 is still in the circular configuration, the tooling head 42 is transferred to a position where it can pick up a metal ring 54 in the load metal ring area 47 using the same vacuum head used for the segments. The metal ring 54 is then transferred into the bonding press 49 and placed on top of the segments.

The tooling head 42 now returns to the linear configuration and the top set of segments is picked up and placed on top of the metal ring 54. In one embodiment, the friction material has an adhesive on one side thus requiring one track of segments that is adhesive side up which is placed below the metal ring and a second track of segments that is adhesive side down to be placed on top of the steel ring. In an alternative embodiment, the adhesive may be on the steel ring in which case only one track is needed. In order to avoid movement of the upper segments it may be necessary to used the heating apparatus to heat the assembly to the point that the adhesive becomes “tacky” before the tooling head is removed.

Once the tooling head 42 is removed from the bonding press 49 the appropriate heat and pressure is applied to bond the assembly together. When the bonding process is complete the tooling head 42 will remove the complete assembly and unload it, preferably to the same conveyor system that brought the steel ring 54 into the machine.

The preferred embodiment includes a second linear actuator, preferably a linear servomotor 144, and a second tooling head 142 that will load the opposite hand segments. For example, if the first tooling head 42 loads left-hand segments the second tooling head 142 would load right-hand segments. The two tooling heads 42, 142 would work in parallel but out of sequence in order to avoid collisions between them.

While the invention has been described with specific embodiments, other alternatives, modifications and variations will be apparent to those skilled in the art. Accordingly, all such alternatives, modifications and variations are intended to be included within the spirit and scope of the appended claims.

1. A method for assembling clutch plates comprising:
placing a plurality of segments side-by-side;
picking-up a required number of segments in a straight line; and
reconfiguring the segments in a circular configuration.

2. The method for assembling clutch plates of claim 1 further including placing a plurality of trapezoidal segments side-by-side.

3. The method for assembling clutch plates of claim 1 further wherein the step of picking-up a required number of segments in a straight line comprises picking-up each segment with a pick-up device.

4. The method for assembling clutch plates of claim 3 further wherein the step of picking-up a required number of segments in a straight line comprises picking-up each segment with a vacuum cup.

5. The method of claim 1 further including forcing the segment to travel along a track that has both a straight portion and a circular portion.

6. The method of claim 1 further including attaching one end of a segmented tooling assembly to a barrel which rotates to wrap the segmented tooling assembly around the barrel in a circular fashion.

7. The method of claim 6 further including further rotating the barrel to unwrap a segmented tooling assembly forcing the segments into a straight track.

8. The method of claim 1 further including attaching the center of a segmented tooling assembly to a barrel, attaching the two ends of the segmented tooling assembly to two arms to wrap the segmented tooling assembly around the barrel.

9. The method of claim 8 further including the two arms unwrapping the segmented tooling assembly from around the barrel.

10. The method of claim 1 further including attaching the center of a segmented tooling assembly to a barrel, and attaching the two ends of the segmented tooling assembly to two links to wrap the segmented tooling assembly around the barrel.

11. The method of claim 10 further including the two links unwrapping the segmented tooling assembly from around the barrel.

12. A clutch assembly comprising:
a plurality of segments placed side-by-side;
a pick-up head segmented such that the pick-up head can be configured in a straight line to pick up a required number of segments; and
the pick-up head further being configurable in a circle to place the segments in a circular configuration.

13. The clutch assembly of claim 12 further wherein the segments are trapezoidal shaped.

14. The clutch assembly of claim 12 further wherein the pick-up head comprises a pick-up device on each segment.

15. The clutch assembly of claim 14 further wherein the pick-up device comprises a vacuum cup.

16. The clutch assembly of claim 12 further including a track that has both a straight portion and a circular portion for the segment to travel.

17. The clutch assembly of claim 12 further including a barrel to which one end of a segmented tooling assembly is attached, the barrel rotating to wrap the segmented tooling assembly around the barrel in a circular fashion.

18. The clutch assembly of claim 17 further wherein the barrel is further rotated to unwrap the segmented tooling assembly from around the barrel.

19. The clutch assembly of claim 12 further including a barrel to which the center of a segmented tooling assembly is attached, and two arms to which the two ends of the segmented tooling assembly are attached to wrap the segmented tooling assembly around the barrel.

20. The clutch assembly of claim 19 further wherein the two arms to which the two ends of the segmented tooling assembly are attached unwrap the segmented tooling assembly from around the barrel.

21. The clutch assembly of claim 12 further including a barrel to which the center of a segmented tooling assembly is attached, and two links to which the two ends of the segmented tooling assembly are attached to wrap the segmented tooling assembly around the barrel.

22. The clutch assembly of claim 21 further wherein the two links to which the two ends of the segmented tooling assembly are attached unwrap the segmented tooling assembly from around the barrel.

23. A method for assembling a clutch assembly comprising:
feeding a strip of friction material an assembly device;
cutting the strip of friction material into trapezoid segments;
feeding the segments in a linear configuration to a pick-up position;
transferring the segments into an assembly nest, the segments reconfiguring from the linear configuration to a circular configuration during this transfer;
placing a ring on top of the segments; and
bonding the assembly together.

24. The method for assembling a clutch assembly of claim 23 further including feeding two parallel strips of friction material into the assembly device placing.

25. The method for assembling a clutch assembly of claim 23 further including cutting the friction material into alternating left-hand, right-hand trapezoids.

26. The method for assembling a clutch assembly of claim 23 further including providing the friction material with an adhesive on one side, placing one track of segments adhesive side up below the ring and placing a second track of segments that is adhesive side down on top of the ring.

27. The method for assembling a clutch assembly of claim 23 further including placing an adhesive on the ring, and utilizing one track.
